(19) United States
(12) Patent Application Publication
(10) Pub. No.: US 2019/0227909 A1
(43) Pub. Date: Jul. 25, 2019

(54) APPLICATION TESTING ON MULTIPLE DEVICE TYPES

(71) Applicant: T-Mobile USA, Inc., Bellevue, WA (US)

(72) Inventors: Samson Kim-Sun Kwong, Bellevue, WA (US); Peter P. Myron, Renton, WA (US); Michael J. Mitchell, North Bend, WA (US)

(73) Assignee: T-Mobile USA, Inc.

(21) Appl. No.: 15/876,537

(22) Filed: Jan. 22, 2018

(51) Int. Cl. G06F 11/36; G06F 17/22

(52) U.S. Cl. CPC G06F 11/3664; H04W 84/042; G06F 17/2247; G06F 11/3612

(57) ABSTRACT

A testing service is provided for testing software applications. A developer of a software application provides the software application to the testing service. The testing service installs and runs instances of the application on respective target devices such as cellular communication devices. The target devices may be of different makes and models, and may have different configurations such as different screen aspect ratios. As the instances execute, the testing service captures the screen output of the target devices and provides it back to the developer. The screen output of the multiple devices is displayed simultaneously to the developer, so that the developer can assess whether the application produces acceptable screen output despite the different configurations of the various devices.

### BACKGROUND

Mobile communication devices such as smartphones, tablet computers, wearable devices, etc. are widely used by consumers for many things other than voice communications. Specifically, these devices are designed so that consumers can install and run various applications, which may perform many different tasks. For example, applications may be used for things such as shopping lists, text messaging, social network communications and sharing, research, weather reporting, news, home automation, and so forth.

There are many different types, makes, and models of mobile communication devices and other computerized devices, which may have various differences such as differences in display size and aspect ratio. However, a single software application is typically expected to be used on any number of these different devices. Accordingly, any given application is typically designed to accommodate the different display characteristics of many different devices.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram of a testing environment that includes multiple target devices of different types.

FIG. 2 is a flow diagram illustrating an example method of testing an application on multiple target devices.

FIG. 3 is a block diagram illustrating an example technique for communicating with multiple target devices.

FIG. 4 is a block diagram illustrating example high-level components of a computing device that may be used as a server computer in the environment of FIG. 1.

### DETAILED DESCRIPTION

The described implementations provide devices, systems, and methods that allow developers to test software on multiple different devices, without necessarily having physical access to the devices. In particular, the described implementations allow a developer to run an application on multiple remotely located devices and to view the screen content of each device as the application runs on each device.

In some embodiments, the application is executed concurrently on each of the multiple devices, and the screen content of the multiple devices is presented simultaneously, within a single composite image. This allows the developer to quickly assess whether the application produces desired graphical output when running on devices of different types and configurations.

More specifically, a test service is made available to a developer over a local-area or wide-area network. The test service has access to multiple devices upon which the developer may want to test a software application. The devices may be of different types and configurations. In particular, the devices may have different hardware, different hardware versions, different operating systems, different software/firmware versions, different user interfaces (UIs) and UI themes, different UI shells, different screen sizes and/or screen aspect ratios, etc., In order to test the software application, the developer provides the application to the test service over the local-area or wide-area network. The test service then installs and runs an instance of the application on each of the multiple devices. As the instances run in parallel and produce graphical output, the test service continuously captures the screen content of each device and provides the screen content to a developer workstation. The screen content for multiple devices is then displayed simultaneously on a monitor of the workstation.

The test service may additionally be configured to perform manual or automated testing of the instances of the application so that the developer can view resulting screen content. In some embodiments, the testing may include providing simulated user input to the application instances. Simulated user input can be provided in parallel to the multiple application instances running on the multiple target devices, and the developer may view the workstation monitor to see the resulting screen content of the respective devices.

In some embodiments, the developer may provide user input by interacting with the devices' screen content as displayed on the workstation monitor. For example, the developer may use an on-screen pointer or other mechanism to select active controls within the screen content of any individual device. In response to input such as this, the test service may provide the user input to all the application instances. Alternatively, the developer may specify scripts to be executed against the devices, and the scripts may include simulated user input. The developer may also specify other, non-graphical types of input, through the use of scripts or other means.

In some embodiments, the test server may be provided by or on behalf of a cellular communication network provider, and the target devices may include examples of the various types of cellular communication devices that have been sold, are currently being sold, and/or that are in development prior to being sold by the provider. This allows a developer to test an application on the most relevant devices using the test service. In this environment, the target devices may be provisioned to operate as part of a cellular communication network, allowing testing of application functionality that may rely upon cellular data connectivity. The devices may also in some cases be configured to communicate through WiFi, through a wired local-area network (LAN) connection, and/or through other mechanisms.

The test service may be made available to multiple developers, and may support multiple banks of target devices so that multiple developers can perform testing at the same time. Rather than physical devices, the devices in some embodiments may comprise virtual devices that emulate physical devices. This may allow banks of target devices to be created dynamically in response to demand.

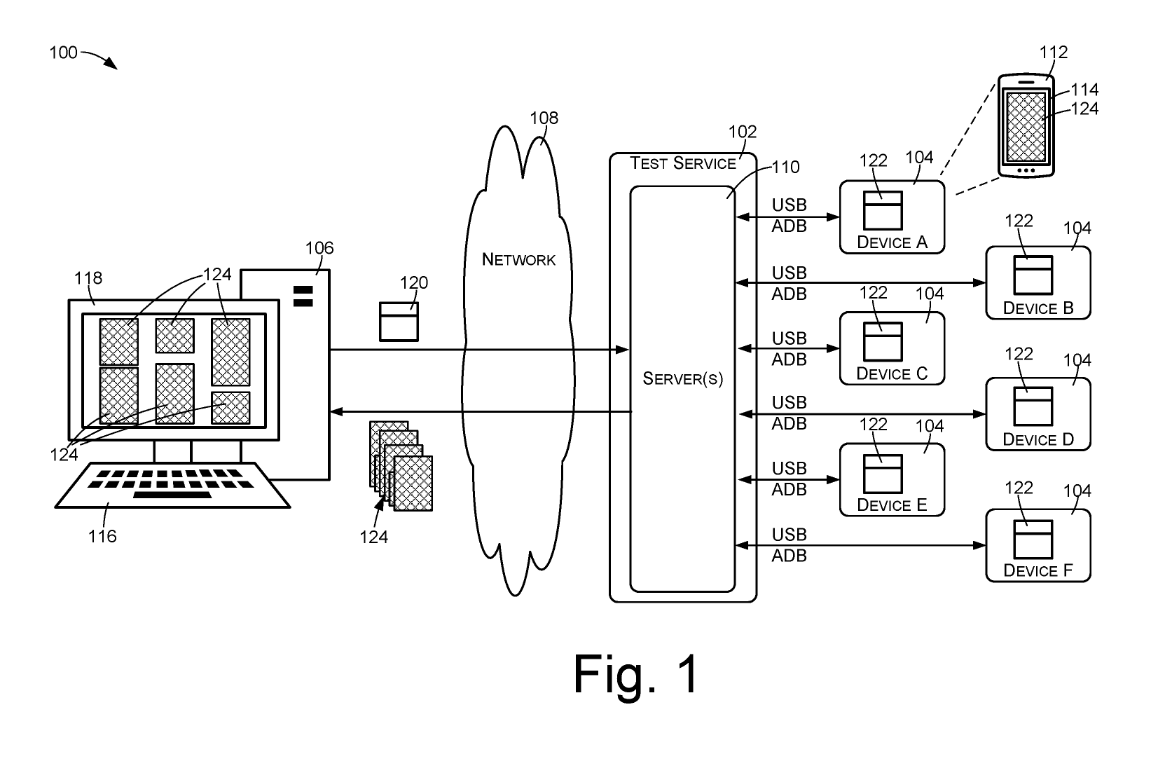

FIG. 1 illustrates a testing environment 100 that allows a developer to test a software application on multiple target devices. In the environment described herein, the target devices comprise different types of cellular communication devices such as smartphones, tablet computers, wearable devices, and other mobile devices, all of which may have different screen sizes and screen aspect ratios. More generally, however, the target devices may comprise various makes, models, and configurations of multiple types of devices, as well as different variants of any particular type, make, or model of device.

The testing environment 100 comprises a test service 102 that performs testing of multiple target devices 104 on behalf of a software developer. For purposes of illustration and discussion, the target devices 104 are labeled as Device A, Device B, Device C, Device D, Device E, and Device F.

The test service 102 is accessed by a developer station 106 through a near-area or wide-area network 108 such as the Internet. The test service 102 may be implemented by one or more computer servers 110, also referred to herein as test servers 110, that are programmed or otherwise configured to implement the functionality that is described herein as being performed by the test service 102.

The developer station 106 may comprise any computer or computer-based device. For example, a developer station 106 may comprise a desktop computer or other similar computer upon which software has been installed to facilitate writing code for the target devices 104. The developer station 106 may have additional software, such an operating system, an Internet or file system browser, and various applications that are used for specific purposes as appropriate.

In some cases, the testing environment 100 may be implemented at least in part by a cellular communications provider for use by developers of software that will be used on communication devices sold by the provider. In cases such as this, the target devices 104 might be located at a facility of the cellular communications network provider and might comprise devices that have been or will be provided for use on a cellular communication network of the provider. Such target devices may include devices that are currently available to consumers, devices that are in development for future release to consumers, and “legacy” devices that are no longer manufactured, produced, or sold, but which may still be in use by consumers.

As an example of a device that might be tested in the environment 100, FIG. 1 shows a smartphone 112 such as is commonly used in conjunction with cellular communication networks. The smartphone 112 has a display screen 114 or other display surface, upon which various types screen content may be displayed. In many cases, the display screen 114 may be sensitive to touch in order to receive user input.

In the example shown by FIG. 1, the test servers(s) 110 of the test service 102 are connected to the target devices 104 through wired communication ports (not shown) of the server(s) 110 and the target devices 104. In the illustrated embodiment, the communication ports comprise USB (universal serial bus) communication ports. Communications between the test server(s) 110 and the target devices 104 may also be performed using other means, such as local-area or wide-area network communications. USB hubs or other components may be used for interfacing between the test server(s) 110 and the target devices 104.

The developer station 106 may be at a location other than that of the target devices 104, such as at the facilities of the developer. For example, the test service 102 and/or the target devices 104 may be at a location in North America while the developer station 106 might be in some other world location such as India, Europe, etc.

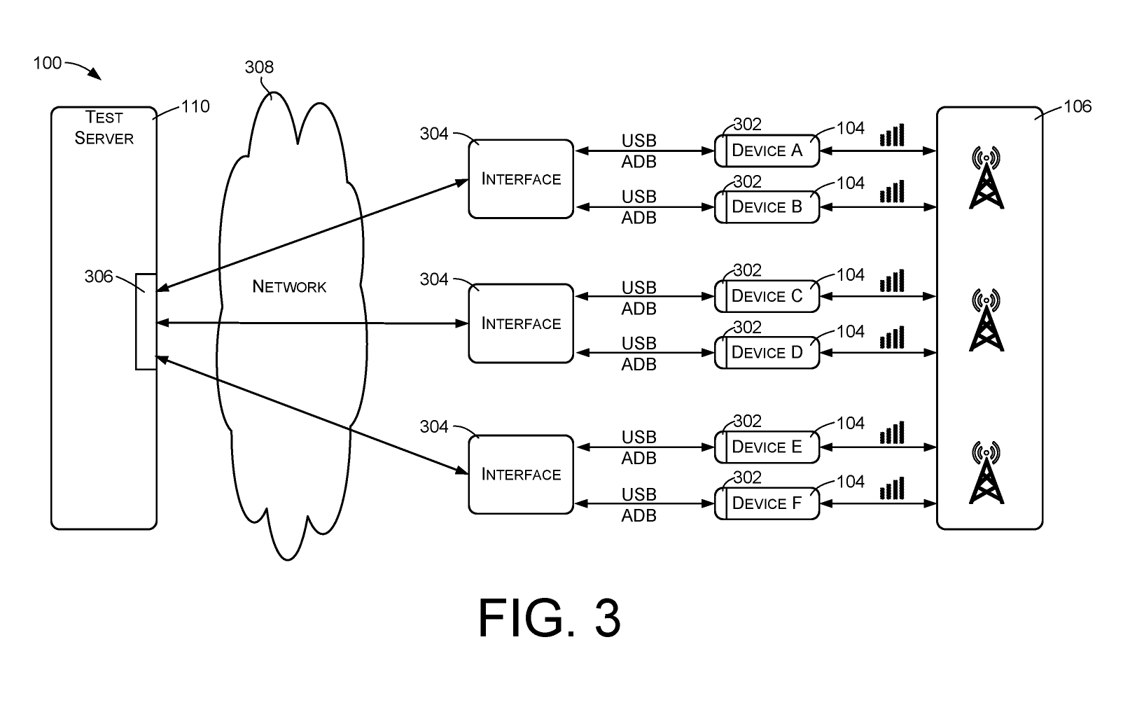

In some embodiments, the target devices 104 may be located apart from the test server(s) 110, and the test server(s) 110 may communicating with the target devices over a local-area or wide-area network. In some cases, the server(s) 110 may communicate with the target devices 104 through one or more interface devices, such as will be described below with reference to FIG. 3.

In operation, a developer uses a keyboard 116 and display monitor 118 of the developer station 106 to write computer code and to create a software application 120. When the developer has created a version of the application 120 that is ready for testing, an executable form of the application 120 is sent to the test service 102 over the network 108. In some cases, this may be done automatically as part of an automated development pipeline in response to a code check-in by the developer.

Upon receiving the application 120 from the developer station 106, the test service 102 uses USB communications to install an instance 122 of the application 120 on each of the target devices 104 and to initiate execution of the application instances.

As the application 120 runs on a target device 104, it produces screen content 124 on the display screen 114 of the target device 104. Screen content may include graphics, animations, video, pictures, text, active and/or selectable controls, etc. Screen content may be represented as multiple sequential images that change over time. Screen content may in some embodiments be represented as or within a video stream. The screen content 124 of each target device 104 is shown in FIG. 1 as a cross-hatched rectangle for purposes of illustration.

The test service 102 is configured to obtain the screen content 124 from the multiple target devices 104 and to send the screen content 124 to the developer station 106, where it is displayed on the monitor 118. The screen content 124 corresponding to the different target devices 104 may be presented simultaneously in a tiled arrangement as shown, in a cascading arrangement, or in any other arrangement. In some embodiments, the screen content 124 corresponding to an individual target device 104 may be displayed within a corresponding pane that can be moved or positioned by the developer, and in some cases the panes corresponding to different target devices may be arranged so that they fully or partially overlay each other.

In some embodiments, the test service 102 may also be configured to analyze the screen content 124 to determine whether the content is as expected. The test service 102 may send the results of this analysis to the developer station 106, where might be displayed on the monitor 118 in conjunction with the screen content 124. In some embodiments, an analysis such as this might be performed by or at the developer station 106.

As mentioned, the test service 102 communicates with each target device 104 using USB-based communications. More specifically, the test service 102 uses USB connections to access logical control interfaces of the target devices 104. For example, the target devices 104 may be based on the Android operating system, and may have what is referred to as ADB (Android debug bridge) interfaces. ADB supports a command/query language and syntax for interacting with Android-based devices, allowing client devices, such as the server(s) 110, to control host devices, such as the target devices 104, for development and testing. For example, ADB allows the test service 102 to install the application instances 122 on the target devices 104, to initiate execution of the application instances 122, to set various operating parameters, to capture application output, to provide simulated user input to an application instances 122, etc.

The described techniques can also be used in conjunction with devices that use operating systems other than the Android operating system. Various types of devices support remote debugging functionality and logical control interfaces, and can be connected in ways similar to those described herein.

In some embodiments, the test service 102 may install a remote screen sharing application on each target device 104 prior to executing the instances of the application 120. The remote screen sharing application may be configured to capture the screen content 124 from the target devices 104 during execution of the application 120 and to provide the screen content 124 to the test service 102.

As the test service 102 receives the screen content 124 from the multiple target devices 104, the test service 102 provides the screen content 124 to the developer station 106 in a form allowing the screen content 124 of the multiple target devices 104 to be presented simultaneously on the monitor 118. For example, the test service 102 may provide video streams or other image representations corresponding to each target device 104. As another example, the test service 102 may create a single composite image or single composite video stream that contains the screen content 124 of all the target devices 104.

In some embodiments, the test service 102 may also obtain various application logs from the target devices 104. The application logs can be presented on the monitor 118 in conjunction with the screen content 124. Alternatively, the test service 102 might analyze the application logs and present the results of the analyses to the developer on the monitor 118.

In some embodiments, the test service 102 may be implemented as a network-based service that uses protocols typically used on the Internet for representing graphical content, such as the HTML (hypertext markup language) protocol. In embodiments such as this, the test service 102 might generate and provide an HTML-based user interface to be viewed using an Internet browser running on the developer station 106. The user interface might allow the developer to upload the application 120 to the test service 102 so that the test service 102 can in turn install and execute the instances 122 of the application 120 on the target devices 104. While the application instances 122 are running, the test service 102 might create a composite HTML document containing the screen content 124 and provide the composite document to the Internet browser for display on the monitor 118. The HTML document might have a panes, panels, or other areas dedicated to the respective target devices 104, in which the screen content 124 of the devices is presented.

In some embodiments, a developer may provide simulated or actual user input for the application 120. As one example, the developer may provide a test script to be executed against the target devices 104, where the test script provides simulated user input to the devices. As another example, the developer may type text on the keyboard 116. As another example, the developer may interact with the screen content 124 displayed on the monitor 118 to generate user input. More specifically, the developer might use a mouse and onscreen pointer to select an active control that is presented within the screen content 124 corresponding to one of the target devices 104, and the selection might be provided to the test service 102.

Upon receiving simulated or actual user input, the test service 102 forwards the user input in parallel to all of the application instances 122. That is, the test service uses the USB/ADB connections to the target devices 104 to simulate user input to the application instances. The resulting screen content 124 will then be reflected on the monitor 118. In some cases, different application instances, running on different devices 104, may result in differing screen content. The developer can view the screen content 124 corresponding to each target device 104 to assess whether the application has responded or otherwise performed as desired in any presented situation.

In some cases, entities may maintain and provide multiple device clusters for various purposes and/or for various types or groups of developers and testers. The target devices 104 are an example of a device cluster. The test clusters may each have the same composition of devices, or different test clusters may have different types of devices.

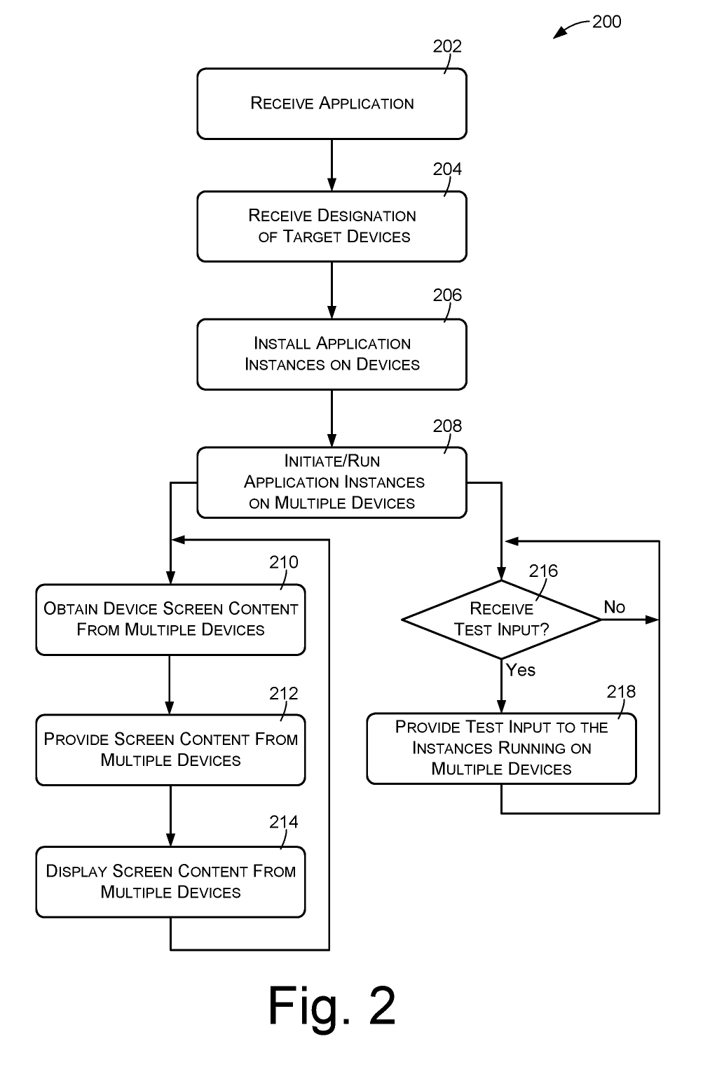

FIG. 2 illustrates an example method 200 for testing software on multiple target devices. In the described embodiments, the target devices comprise of cellular communication devices provisioned to operate as part of a cellular communications network. However, the target devices may include various other types of computing components, including both physical devices and virtual devices, that produce display output. In some cases, the target devices may include devices having differing configurations, such as devices having displays of different sizes and/or aspect ratios. Target devices may vary in other ways, such as by having different hardware, different hardware versions, different operating systems, different software/firmware versions, different user interfaces (UIs) and UI themes, different UI shells, etc.

At least portions of the method 200 may, as an example, be performed by the test service 102 or the servers 110 of the test service 102. However, the actions shown in FIG. 2 may in general be performed by any number of different combinations of hardware and/or software components, and communications between the various components may take any of various different forms, not limited to those shown in FIG. 1.

An action 202 comprises obtaining a software application for testing, where the software application is executable to generate screen content. For example, the action 202 may comprise receiving the software application over a local-area or wide-area network from a remotely located developer station or another device.

An action 204 comprises receiving a designation of target devices upon which the software application is to be tested. Such a designation may be received from the developer or the developer station, for example, in conjunction with submission of the software application to the test service. In some embodiments, the action 204 may be implemented by presenting a menu of available target devices to the developer and allowing the developer to select any of the available target devices for testing of the software application.

An action 206 comprises installing instances of the application on respective target devices that have been designated in the action 204. In the embodiment shown in FIG. 1, the action 206 may be performed by communicating through the ADB interfaces of the target devices 104.

An action 208 comprises initiating and/or running the application instances on the designated target devices. In some embodiments, the application instances may run concurrently on the multiple target devices. That is, some or all of the designated target devices may be configured to run the application at the same time.

An action 210, performed as the instances run on the respective target devices 104 after the action 208, comprises receiving screen content that is produced on the displays of the designated target devices 104 by the application instances. As mentioned above, a screen sharing application or other type of application may be installed on the target devices prior to running the application instances. A screen sharing application such as this captures screen images and provides a stream of screen images of each target device upon which it is installed. In other embodiments, a camera or cameras may be used to capture images or video of displayed screen content.

Screen content may include any type of visual output of the target devices that has the potential for being affected by execution of the software application. Screen content may include sequences of changing content images, for example. Screen content of a device or of multiple devices may be represented in some cases as one or more video streams.

An action 212 comprises providing the screen content for simultaneous display to a developer or other person. For example, the action 212 may comprise creating a composite view of the screen content, showing the screen content that is generated by the multiple running instances of the application. As another example, the screen content from the designated target devices may be embedded within an HTML (hypertext markup language) document, and the HTML document may be provided to a developer station such as the developer station 106 of FIG. 1. The HTML document may be composed to show the screen content from the respective target devices in different respective display areas, such as windows or panes within the HTML document.

An action 214, which may be performed by a developer station or other equipment associated with the developer, comprises displaying the screen content on a monitor or other 214 associated with the developer or the developer station. In particular, the action 212 comprises simultaneously displaying the screen content that is being or has been produced on the displays of the designated target devices. The action 214 may also include displaying the results of any automated analyses that have been performed by the test service. For example, the action 214 may include displaying notifications of any detected visual degradations or failures.

The actions 210, 212, and 214 are repeated in a loop so that the composite view of the screen content is continuously updated, allowing a developer to view responses of the different instances to various types of stimuli.

Another loop is also initiated as the application instances are running, subsequent to the action 208. This loop comprises an action 216 of receiving test input and an action 218 of providing the test input to the application instances that are running on the designated target devices.

For example, the test input may comprise simulated user input intended for one or more instances of the application, provided either manually by a developer during testing or automatically as part of an automated test procedure. In some cases, the test input may be generated in response to human interaction with a representation of the displayed output of one of the target devices, which is displayed within a composite view on the developer station or on a monitor associated with the developer or developer station.

More specifically, the screen content of the target devices may include controls that are provided for a user to select and/or for a user to provide input text. At some point, as the screen content is displayed on the developer station, the developer may use the input/output capabilities of the developer station to interact with a particular instance of the application and/or to provide user input to the application instance. For example, the developer might select a menu item displayed within the screen content of an individual target device. In response, the action 218 provides this input either to the application instance running on that individual target device, or in parallel to the multiple instances running on the multiple target devices.

After or during input to one or more of the application instances, the actions 210, 212, and 214 continue to execute, allowing the developer to view the responses of the application instances to the test input.

FIG. 3 illustrates another example of how the test service 102 of FIG. 1 might communicate with multiple target devices. In particular, FIG. 3 illustrates another example of how communications might be implemented between the test server(s) 110 and the target devices 104.

In this embodiment, each target device 104 has a wired communication port 302 such as a USB (Universal Serial Bus) port. In addition, each target device 104 implements a logical control interface that can be accessed through the USB port for interacting with and controlling the target device 104. In certain embodiments, the logical control interface may comprise an ADB (Android Debug Bridge) interface as described above. In other embodiments, logical control interfaces may support remote debugging connections and protocols other than ADB.

Each target device 104 is connected by a wired USB connection to an interface device 304. As an example, each interface device 304 may comprise a relatively inexpensive diskless, single-board computer or controller having an Ethernet network port and one or more other wired communication ports such as USB device ports. Each interface device 304 may be configured and programmed by way of a code image that is stored on a removable memory card. For example, an interface device 304 may have a slot into which a removable SD memory card is inserted, and the code image for the interface device 304 may be stored on the SD memory card. The interface device 304 may be easily reconfigured by changing its memory card. Each interface device 304 may support any number of target devices 104. Various other types of devices may also be used as interface devices.

In the example shown by FIG. 3, each interface device 304 is connected to a corresponding target device 104 through the wired communication port 302 of the target device 104. Specifically, each interface device 304 is connected by USB cables to the USB communication ports 302 of two target devices 104, using respective USB communication ports (not shown) of the interface device 304.

The test server 110 has a network interface or adapter 306, such as an Ethernet adapter or Wi-Fi interface, that enables communications through a local-area or wide-area network 308, which may or may not be the same network as the network 108 of FIG. 1. Each interface device 304 similarly has a network interface (not shown), such as an Ethernet adapter or Wi-Fi interface, that is connected to enable communications through the network 308. The network 308 may comprise or include the Internet in some embodiments.

The test server 110 is configured to communicate through its network interfaces 306 and the network 308 with the respective interface devices 304. Each interface device 304 may be configured to automatically establish a VPN (Virtual Private Network) communication channel with the test server 110, and within the resulting virtual network to establish a TCP (Transport Control Protocol) connection with the test server 110. ADB communications can then be conveyed between the test server 110 and the interface devices 304 over TCP connections between the test server 110 and the interface devices 304. An interface device 304 at a particular location is configured to relay ADB communications between the test server 110 and the target devices 104 at that location. This results in an end-to-end communication channel between the test server 110 and each of the target devices 104. Each channel extends from the test server 110 to one of the target devices 104 via one of the interface devices 304 and the USB port 302 of the target device 104.

In the example of FIG. 3, each of the target devices 104 is a cellular communications device, and is provisioned to operate as part of or in conjunction with a wireless cellular communications network 310.

Although various elements of FIGS. 1 and 3 are shown and described as being discrete devices or components for purposes of discussion, any of the illustrated computing elements may in practice comprise one or more physical, virtual, or otherwise abstracted cluster or network of machines and/or devices. For example, although the test server is described as a single entity, the term “test server” is intended to reference any one or more computing devices, including physical devices and virtual computing units, and including network-based devices that are commonly referred to as being in the cloud.

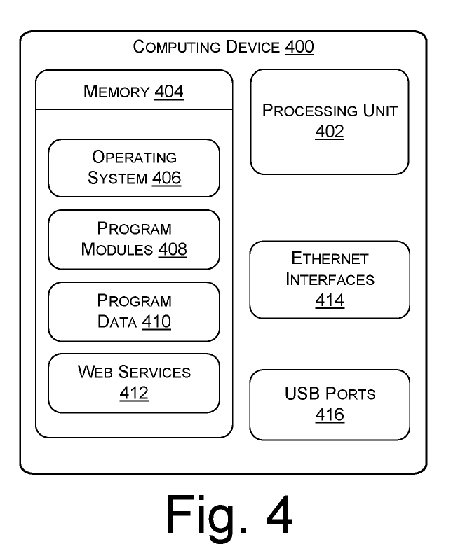

FIG. 4 is a block diagram of an illustrative computing device 400 such as may be used to implement one of the test servers 110. In various embodiments, the computing device 400 may include at least one processing unit 402 and memory 404. Depending on the exact configuration and type of computing device, the memory 404 may be volatile (such as RAM), non-volatile (such as ROM, flash memory, etc.) or some combination of the two. The memory 404 may include an operating system 406, one or more program modules 408, and may include program data 410. The memory 404 may also include a web services component 412 for interfacing with a developer and/or a developer station. The memory may also include data storage devices (removable and/or non-removable) such as, for example, magnetic disks, optical disks, or tape.

The memory 404 may comprise non-transitory computer storage media. Such non-transitory computer storage media may include volatile and nonvolatile, removable and non-removable media implemented in any method or technology for storage of information, such as computer readable instructions, data structures, program modules, or other data. The non-transitory computer-readable storage media may further include, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400.

In various embodiments, any or all of the memory 404 may store programming instructions which, when executed, implement some or all of the function functionality described above as being implemented by the test server 110.

The computing device 400 may have one or more Ethernet interfaces 414, which may be used for connecting to a wide-area network such as the Internet. As described above, the computing device 400 may have multiple USB ports 416 for communications with the target devices 104. Alternatively, the computing device 400 may communicate with the target devices in accordance with the arrangement shown in FIG. 3.

The computing device 400 may have various other elements such as a keyboard, a mouse, a touch-sensitive display, voice input device, etc. Output device(s) such as a display, speakers, a printer, etc. may also be included.

Although features and/or methodological acts are described above, it is to be understood that the appended claims are not necessarily limited to those features or acts. Rather, the features and acts described above are disclosed as example forms of implementing the claims.

1. A system comprising:
one or more servers that are accessible over a network by a developer station, the one or more servers being configured to perform actions comprising:
receiving, from the developer station, an application for testing;
receiving a designation of multiple devices, each of the devices having a display;
installing instances of the application on respective devices;
concurrently running the instances of the application on the devices;
receiving screen content produced on the displays of the multiple devices by the instances of the application; and
providing the screen content to the developer station to enable simultaneous display, on the developer station of the screen content produced on the displays of the multiple devices.

2. The system of claim 1, wherein the designation is of devices having respectively different configurations.

3. The system of claim 1, wherein the designation is of devices having at least two different display aspect ratios.

4. (canceled)

5. The system of claim 1, the actions further comprising:
creating an HTML (hypertext markup language) document that shows, in different areas, the screen content produced on the displays of the multiple devices;
wherein providing the screen content comprises providing the HTML document.

6. The system of claim 1, at least one of the devices comprising a cellular communication device provisioned to operate as part of a cellular communications network.

7. The system of claim 1, the actions further comprising:
receiving input generated in response to interaction with an instance of the application displayed by the developer station;
providing the input to the instances of the application; and
continuing receiving and providing the screen content.

8. One or more computer servers configured to perform actions comprising:
obtaining an application for testing;
concurrently running instances of the application on respective devices;
receiving screen content produced on displays of the devices by the instances of the application; and
providing for simultaneous display on a monitor the screen content produced on displays of the devices.

9. The one or more computer servers of claim 8, wherein providing the screen content comprises providing one or more HTML (hypertext markup language) documents that include the screen content.

10. The one or more computer servers of claim 8, wherein providing the screen content comprises creating a composite view that shows the screen content produced on the displays of the devices by the instances of the application.

11. The one or more computer servers of claim 8, wherein the devices include devices having at least two different aspect ratios.

12. The one or more computer servers of claim 8, wherein the devices comprise cellular communication devices provisioned to operate as part of a cellular communications network.

13. The one or more computer servers of claim 8, the actions further comprising:
receiving user input for an instance of the application;
providing the user input to the instances of the application; and
continuing receiving the screen content and providing the screen content for simultaneous display on the monitor.

14. The one or more computer servers of claim 8, wherein obtaining the application comprises obtaining the application over a wide-area network.

15. A method, comprising:
receiving a software application that is executable to generate screen content;
executing instances of the application on respective computing components; and
providing screen content generated by the instances of the application on the respective computing component for simultaneous display,
wherein the computing components include devices having at least two different user interfaces.

16. The method of claim 15, wherein each of the computing components comprises:
a physical device; or
a virtual device.

17. The method of claim 15, further comprising:
receiving input provided by human interaction with screen content of an instance of the application;
providing the input to the instances of the application; and
continuing providing the screen content for simultaneous display.

18. (canceled)

19. The method of claim 15, wherein providing the screen content comprises providing one or more HTML (hypertext markup language) documents that include the screen content.

20. The method of claim 15, wherein the computing components include devices having at least two different aspect ratios.
